(19) United States
(12) Patent Application Publication
(10) Pub. No.: US 2018/0357925 A1
(43) Pub. Date: Dec. 13, 2018

(54) REAL-TIME COGNITIVE ACCESSIBLE DATA VISUALIZATION ADAPTATION

(71) Applicant: International Business Machines Corporation, Armonk, NY (US)

(72) Inventors: Susann Keohane, Austin, TX (US); Fang Lu, Billerica, MA (US); Erich Manser, Littleton, MA (US)

(73) Assignee: International Business Machines Corporation, Armonk, NY (US)

(21) Appl. No.: 15/619,501

(22) Filed: Jun. 11, 2017

(51) Int. Cl. G09B 21/00; G06F 3/0484

(52) U.S. Cl. CPC G09B 21/008; G06F 2203/04806; G06F 3/04845; G09B 21/006

(57) ABSTRACT

Profile data associated with a user of a device is configured. The profile data indicates a condition of the user associated with a visual impairment. Image data associated with an object including visual information displayed thereon is captured. The image data is displayed in a display associated with the device. A frustration level associated with the user is evaluated. The frustration level is indicative of the user viewing the image data in the display. Whether an enhancement condition has been met is determined based upon the condition of the user and whether the frustration level has exceeded a threshold value. Responsive to determining that the at least one enhancement condition has been met, the image data is converted to enhanced image data. The enhanced image data includes an increased readability of the visual information displayed on the object.

### TECHNICAL FIELD

The present invention relates generally to a method, system, and computer program product for improving accessibility of visual information for a user. More particularly, the present invention relates to a method, system, and computer program product for real-time adaptation of cognitive accessible data visualization information.

### BACKGROUND

Discerning objects at a distance, especially objects containing textual information, often presents a challenge to people who have visual impairments or other physical conditions. Examples of such conditions include low visual acuity, near-sightedness, and color-blindness. As a result, the user may have difficulty in reading the textual information. For example, a commuter may have a difficult time reading a train schedule from a distance due to some visual impairment of the user. In addition, other conditions such as low lighting in the physical environment, or the fact that printed or displayed text of an object may not be clear to start with, may impede a user's visual comprehension of textual information. These conditions may lead to a user experiencing frustration as well as the possibility of missed opportunities, such as the user missing a train at a time when the person has an urgent need to arrive at the destination.

### SUMMARY

The illustrative embodiments provide a method, system, and computer program product. An embodiment of a method includes configuring profile data associated with a user of a device, the profile data indicating a condition of the user associated with a visual impairment. The embodiment includes capturing image data associated with an object, the object including visual information displayed thereon. The embodiment includes displaying the image data in a display associated with the device. The embodiments includes evaluating a frustration level associated with the user, the frustration level indicative of the user viewing the image data in the display. The embodiment includes determining whether an enhancement condition has been met based upon the condition of the user and whether the frustration level has exceeded a threshold value. The embodiment includes responsive to determining that the at least one enhancement condition has been met, converting the image data to enhanced image data, the enhanced image data including an increased readability of the visual information display on the object.

Another embodiment further includes wherein determining the frustration level further comprises determining one of a sentiment of the user, a facial expression of the user, and biometric data associated with the user.

Another embodiment further includes receiving historical data associated with the user, determining a current location of the device, and determining, from the historical data, whether a current context associated with the current location is similar to a previous context associated with a previous location. Another embodiment includes wherein the enhancement condition is further based upon determining that the current context is similar to the previous context.

Another embodiment further includes wherein the enhancement condition is determined using one or more of calendar data associated with the user, historical data associated with the user, user biometric data, and environmental data associated with an environment of the user.

Another embodiment further includes wherein converting the image data to enhanced image data further comprises increasing legibility of a portion of the visual information. Another embodiment further includes wherein converting the image data to enhanced image data further comprises increasing a contrast of a portion of the image data. Another embodiments further includes wherein converting the image data to enhanced image data further comprises changing one or more colors of a portion of the image data.

Another embodiments further includes wherein converting the image data to enhanced image data further comprises changing a font of a portion of the visual information. Another embodiments includes wherein converting the image data to enhanced image data further comprises zooming in on a portion of the image data including a portion of the visual information. Another embodiments further includes wherein converting the image data to enhanced image data further comprises changing an orientation of the image data.

Another embodiments further includes determining whether the frustration level associated with the user continues to exceed the threshold value, and responsive to determining that the frustration level continues to exceed the threshold, presenting the visual information in an alternate format.

Another embodiments further includes presenting the visual information in the alternate format further includes presenting the visual information in an audio format. Another embodiment further includes wherein the visual information includes textual information.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration of a mobile device in accordance with an illustrative embodiment;

FIG. 4 depicts a block diagram of an example scenario for real-time adaptation of cognitive accessible data visualization information in accordance with an illustrative embodiment; and

FIG. 5 depicts a flowchart of an example process for real-time adaptation of cognitive accessible data visualization information in accordance with an illustrative embodiment.

### DETAILED DESCRIPTION

The illustrative embodiments recognize that the presently available tools or solutions do not address these needs or provide adequate solutions for these needs. The illustrative embodiments used to describe the invention generally address and solve the above-described problems and other problems related to real-time accessibility of visual information.

Various embodiment described herein are directed to receiving image data associated with an object displaying data, and intelligently providing a user with an enhanced view of the data. The enhanced view according to the illustrative embodiments provide greater readability as compared to presently available methods. The enhancement provided by an embodiment is based upon one or more factors such as, but not limited to, a visual impairment or other physical condition of the user, a frustration level of the user, user preferences or other profile data, user calendar data, user historical data, user biometric data, and environmental data associated with the environment of the user.

In one or more embodiments, a user utilizes a device, such as a cell phone or personal digital assistant (PDA), to capture image data associated with an object displaying textual or other visual data. The device enabled by an embodiment determines whether certain factors or conditions have been met, and the improved device automatically displays an enhanced version of the image data if the certain factors or conditions have been met.

In an example scenario, John, a user having a visual impairment, is standing at a train station in Paris. John is frowning because he cannot see a display of a train schedule clearly enough to discern the textual information displayed in the train schedule. John has just finished attending a conference and is on his way home to Boston. John urgently needs to take a particular train so that he can get to the airport in time to catch his flight to Boston. John aims the front-facing camera of his improved cell phone at the display of the train schedule, and the improved cell phone captures image data including the display of the train schedule. John's improved cell phone determines whether certain conditions have been met to enable enhancement of the image data.

John uses an improved cell phone, to wit, a cell phone that has been improved or enhanced by an embodiment described herein. Based on user profile data indicating that John has a visual impairment, calendar data indication that John urgently needs to catch the train, and a determination that John's frustration level has exceed a certain threshold, John's improved cell phone determines that the image data is to be automatically enhanced. The improved cell phone may determine John's frustration level based upon biometric factors such as by performing cognitive processing of an image of John's face obtained from a rear-facing camera to determine that John's facial expressions indicate frustration, or measuring an elevated heart rate. John's improved cell phone then converts the original image data to enhanced image data including greater intelligibility and/or readability of the visual data and displays the enhanced image data in a display of the cell phone. In example, the improved cell phone may enhance the image data by converting the image data from a color image to a black and white image and/or increasing the contrast of the image data. John's improved cell phone may further enhance the readability of the visual data by processing the image data to zoom in a portion if the image data including the schedule information that John needs.

Further, John's improved cell phone may determine that John is still frowning, squinting, and his heart rate is increasing as an indication that John still cannot discern the visual information. John's improved cell phone may then provide the schedule information to John in an alternative form such as an audio form. In particular, John's improved cell phone may read aloud the schedule information to John via a speaker of the improved cell phone so that John can obtain the schedule information.

The illustrative embodiments are described with respect to certain types of visual information, formats or types of visual information, contents, transmissions, responses, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

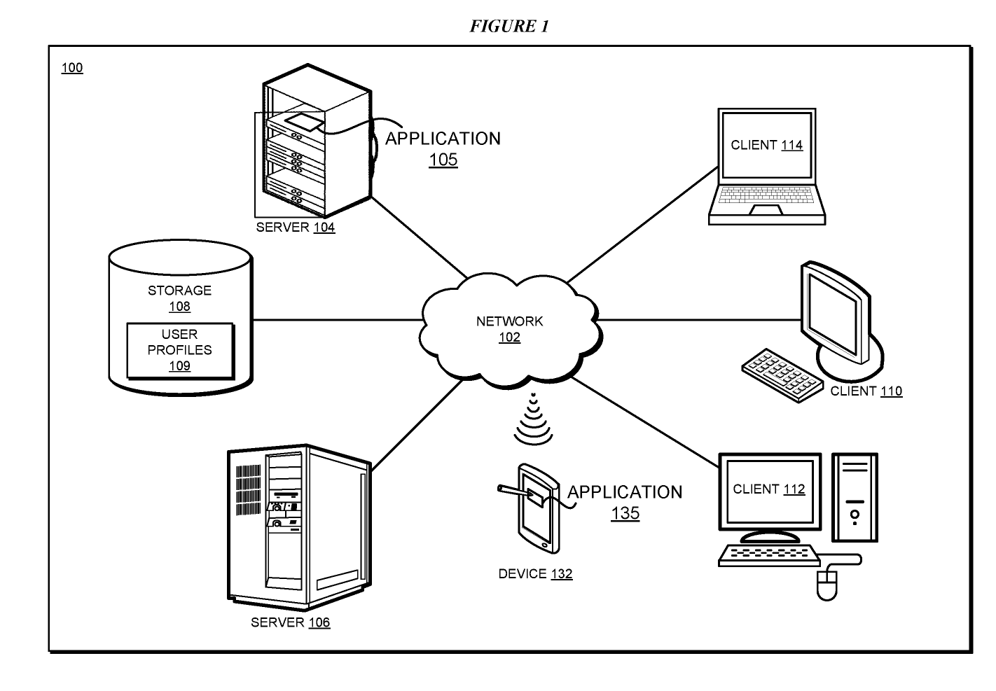

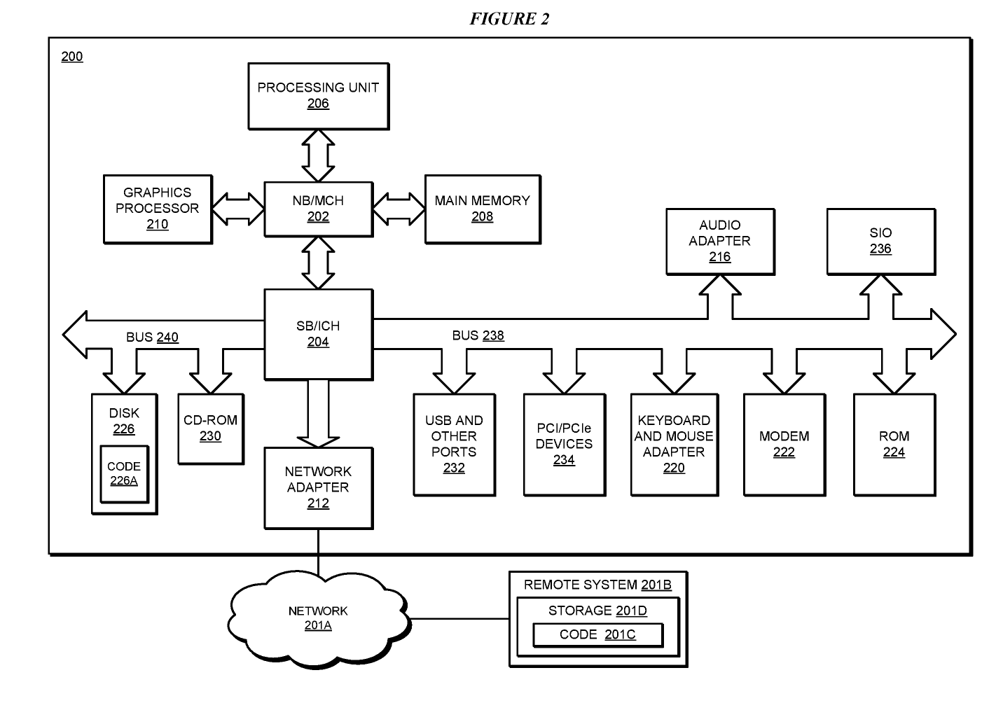

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon. In particular embodiments, one or more of client 110, 112, or 114 is associated with a call agent of a product or service provider and is configured to facilitate voice and/or text communication with a user associated with device 132. In particular embodiments, a telephone 136 is associated with the call agent and is configured to facilitate the call agent to have voice communication with the user during a call.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a mobile device described herein. For example, device 132 can take the form of a smartphone, a PDA, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein in the manner of a remote server-based application or service. Application 105 may store user profile information locally, or use storage unit 108 that is accessible over network 102 to store user profile data in a secure manner within a user profiles database 109. Application 105 may further determine whether certain conditions described herein have been met for automatically initiating enhancement of image data captured by device 132, and send an indication to device 132 to enhance the image data or alternately, to enhance the image data and send the enhanced image data to device 132.

As another example, application 135 implements an embodiment described herein in the manner of a locally operating application or feature of device 132. In particular embodiments, application 135 stores user profile information within a database in memory of device 132, may use a remote data storage such as storage 108 to store user profile information, or may use some combination of local and remote storage within the scope of the illustrative embodiments. Application 135 may further receive image data associated with an object including visual information, and determine whether certain conditions have been met certain conditions described herein have been met for automatically initiating enhancement of image data captured by device 132, enhancing the image data if the certain conditions have been met, and displaying the enhanced image data to a user within a display of device 132. In particular embodiments, the visual information includes one or more of textual information, signs, and/or symbols representing an idea, concept, or instructions of an action to be performed perform.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 and 134 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

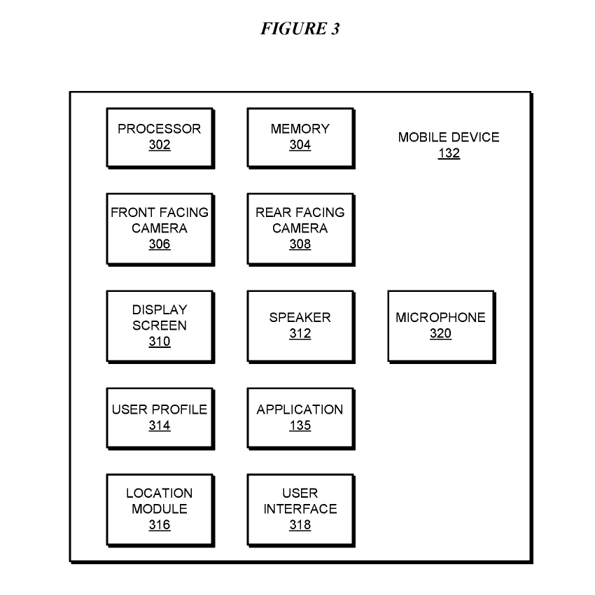

With reference to FIG. 3, this figure depicts a block diagram of an example configuration of a mobile device in accordance with an illustrative embodiment. Mobile device 132 includes a processor 302, a memory 304, a front facing camera 306, a rear facing camera 308, a display screen 310, a speaker 312, a user profile component 314, location module 316, a user interface component 318, a microphone 320, and application 135. Processor 302 is configured to retrieve instructions from memory 304 and execute the instructions to perform various operations of mobile device 132 as described herein. In one or more embodiments, front facing camera 306 is configured to capture image data associated with an object in front of a user of mobile device 132. In one or more embodiments, rear facing camera 308 is configured to an capture image data associated with an image of the user. In one or more embodiments, display screen 310 is configured to display image data and enhanced image data associated with an object including visual information. In one or more embodiments, speaker 312 is configured to provide an audio output to the user.

In one or more embodiments, user profile component 314 is configured to store user profile information associated with a user of mobile device 132. In particular embodiments, user profile component is configured to store one or more of user preference information, user condition information or user medical information, historical data associated with the user, user calendar data, and biometric data associated with the user. In one or more embodiments, location module 316 is configured to receive information indicative of a location of mobile device 132. In a particular embodiment, location module 316 includes a global positioning system (GPS) module. In one or more embodiments, user interface 318 is configured to provide one or more input devices to allow the user to interact with mobile device 132. In one or more embodiments, microphone 320 is configured to receive an audio input from the user.

Application 135 is an example of application 135 that executes in mobile device 132 of FIG. 1. In particular embodiments, application 135 is an application that runs in the background of device 135 and performs one or more functions of mobile device 132 as described herein including initiating capture of image data, determining whether certain enhancement conditions have been met, and enhancing the image data to increase intelligibility of visual information within the image if the enhancement conditions have been met.

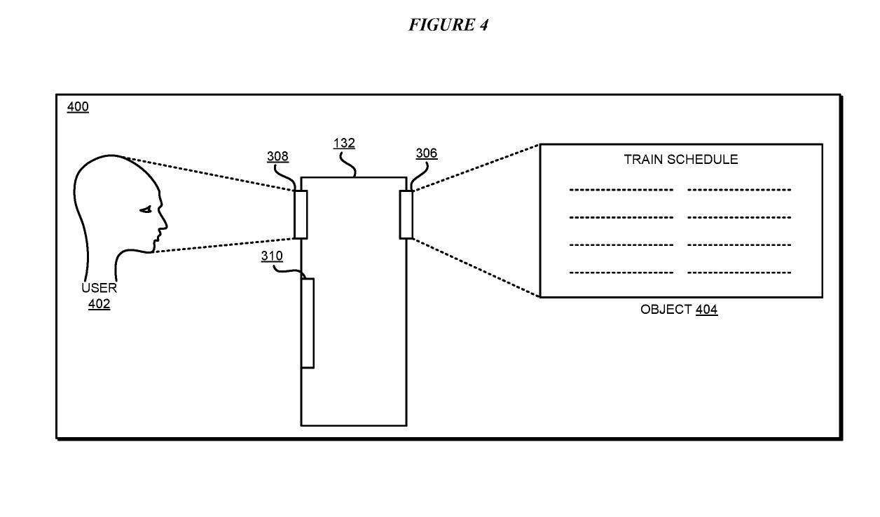

With respect to FIG. 4, this figure depicts a block diagram of an example scenario 400 for real-time adaptation of cognitive accessible data visualization information in accordance with an illustrative embodiment. In the particular scenario illustrated in FIG. 4, a user 402 associated with mobile device 132 wishes to read visual information displayed on an object 404 located within an environment or at a particular location. In the particular embodiment illustrated in FIG. 4, object 404 includes a train schedule that user 402 wishes to read but is unable to do so due to a visual impairment or other medical/physical condition of the user.

In an embodiment, mobile device 132 determines a location of mobile device 132 and uses the location information to determine whether user 402 is in a specific location in which enhancement of visual information in an image may be desired, such as a train stop billboard or an airport arrival/departure screen. In an embodiment, mobile device 132 may further access historical data in the user's profile indicating that the user has struggled to read information at the current location in the past or in a location having a similar or matching context to the current location to determine whether enhancement would be desirable at the present time. In an embodiment, mobile device 132 collects historical data associated with user 402 and apply the same image enhancement operations for user 402 when user 402 encounters a similar contextual environment. In particular embodiments, a context represents a particular condition or circumstance in which an event occurred such a location time of day, and/or environment. For example, mobile device 132 may use historical data to determine that user 402 has previous struggled at a similar calendar event to a current calendar event, or when performing a similar activity such as travelling by train, or ordering food at a fast food restaurant.

In an embodiment, mobile device 132 accesses medical information or other user condition information stored in the user profile to determine whether the user has a visual impairment or other condition in which enhancement of visual information may be desired. For example, mobile device 132 may analyze medical history data or other profile data of user 402 to determine whether user 402 has a condition related to impaired vision such as low visual acuity, near-sightedness, color-blindness, etc. In an embodiment, mobile device 132 uses calendar data and/or historical data from the user profile to determine an urgency of switching mobile device 132 to a mode in which image enhancement is performed on image data to increase the legibility, readability, and/or intelligibility of visual information in the image data. For example, mobile device 132 may determine urgency based on determine an immediate need of user 402 such as that user 402 needs to take the next train to go home. In another example, mobile device 132 may determine urgency based on various information such as a sentiment of user 402, a personal calendar schedule of user 402, a train schedule (e.g., last train of the day), location, time of day, etc.

In an embodiment, user 402 uses front facing camera 306 of mobile device 132 to capture image data associated with object 404 and display the image data within display screen 310. In the embodiment, mobile device 132 determines a frustration level associated with user 402. In one or more embodiments, mobile device 132 utilizes one or more of sentiment of user 402, facial expressions of user 402, and biometric data of user 402 collected over one or more time intervals to determine the frustration level associated with user 402. In a particular embodiment, mobile device 132 captures image data of a face of user 402 and uses the image data to determine whether facial expressions of user 402 indicate that a frustration level of user 402 has exceeded a threshold value. In another embodiment, microphone 320 of mobile device 132 collects speech data associated with user 402 to determine a sentiment or immediate need of user 402. In one or more embodiments, mobile device 132 and/or server 105 generates a data model using historical data associated with user 402 and performs pattern recognition through a machine learning algorithm to determine a frustration level of user 402.

In an embodiment, mobile device 132 determines whether one or more enhancement conditions have been met based upon one or more factors including, but not limited to, a current location associated with user 402, a current time, a visual impairment or other physical condition of user 402, the frustration level of user 402, user preferences or other profile data associated with user 402, calendar data associated with user 402, historical data associated with user 402, biometric data associated with user 402, and environmental data, such as a light level, associated with the environment of user 402.

In the embodiment, responsive to mobile device 132 determining that the one or more enhancement conditions have been met, mobile device 132 automatically processes the original image data to convert and/or transform the original image data to enhanced image data in which the enhanced image data includes an increased intelligibility and/or readability of the visual information contained in the image data. In particular embodiments, enhancing of the image data to increase the intelligibility of the visual information includes one or more of converting color image data to black and white image data, increasing contrast of the image data to increase legibility of the visual information, changing one or more colors of the image data, changing a font of the visual information, zooming in on a portion of the image data including a portion of the visual information desired to be understood by user 402, and changing the orientation of the image data within display screen 310.

In one or more embodiments, mobile device 132 enhances only a portion of the image data rather than the image data of the entire image. In an embodiment, mobile device 132 detects a portion of the image data in which the visual information, such as text, appears and enhances only that portion of the image data. In some embodiments, not even all of the text appearing in the image data may have to be enhanced. For example, some text may be perfectly readable while other fine print may not be. In such a case, in a particular embodiment mobile device 132 only enhances that portion of the textual portion of the entirety of the image data which meets an enhancement condition.

In the embodiment, mobile device 132 displays the enhanced image data on display screen 310 of mobile device 132 to allow user 402 to read and/or understand the visual information contained in the image of object 404. In an embodiment, mobile device 132 may determine that user 402 is still experiencing frustration due to user 402 still being unable to discern the visual information in the enhanced image data. In such an embodiment, mobile device 132 is further configured to provide the visual information to user 402 in an alternate format such as through providing the visual information in an audio format to user 402, initiating a phone call to a call center for further assistance, connecting mobile device 132 to a website or server containing the visual information, or displaying the visual information in a text form within display screen 310 of mobile device 132.

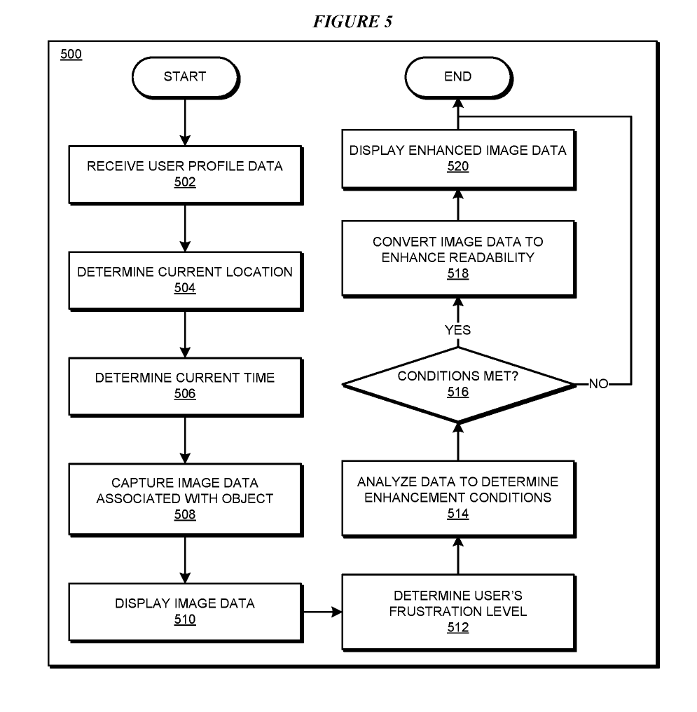

With reference to FIG. 5, this figure depicts a flowchart of an example process for real-time adaptation of cognitive accessible data visualization information in accordance with an illustrative embodiment In accordance with various embodiments, portions of process 500 can be implemented in application 135 or application 105 in FIG. 1.

In block 502, an application receives user profile data from a user profile associated with a user. In block 504, the application determines a current location of a mobile device, such as mobile device 132, associated with the user. In particular embodiments, the application determines the location of mobile device 132 using GPS data and/or cellular data. In block 506, the application determines a current time associated with the current location.

In block 508, the application causes the mobile device to capture image data associated with an object in which the object includes a representation of visual information. In block 510, the application causes the mobile device to display the image data in a display screen associated with the mobile device. In block 512, the application determines the user's current frustration level. In one or more embodiments, mobile device 132 utilizes one or more of a sentiment of the user, facial expressions of the user, and biometric data associated with the user collected over one or more time intervals to determine the frustration level associated with the user.

In block 514, the application analyzes various data to determine the status of one or more enhancement conditions. In particular embodiments, the enhancement conditions may include, but not limited to, the current location associated with the user, a current time associated with the location, a visual impairment or other physical condition of the user, the frustration level of the user, user preferences or other profile data associated with the user, calendar data associated with the user, historical data associated with the user, biometric data associated with the user, and environmental data associated with an environment of the user.

In block 516, the application determines whether the enhancement conditions have been met. If the enhancement conditions have not been met, the application continues to display the original image data within the display screen of the mobile device and the application ends process 500. Responsive to determining that the enhancement conditions have been met, in block 518, the application converts the image data to enhance image data in which the enhanced image data includes enhanced readability or intelligibility of the visual information. In block 520, the application displays the enhanced image data including the enhanced visual information within the display of the mobile device and the application ends process 500.

Although various embodiments describe the visual information as being stored in a textual form, it should be understood that in other embodiments other types of visual information in other formats may be enhanced for greater intelligibility such as signs and symbols.

Thus, a computer implemented method, system or apparatus, and computer program product are provided in the illustrative embodiments for real-time adaptation of cognitive accessible data visualization information and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
configuring profile data associated with a user of a device, the profile data indicating a condition of the user associated with a visual impairment;
capturing image data associated with an object, the object including visual information displayed thereon;
displaying the image data in a display associated with the device;
evaluating a frustration level associated with the user, the frustration level indicative of the user viewing the image data in the display;
determining whether an enhancement condition has been met based upon the condition of the user and whether the frustration level has exceeded a threshold value; and
responsive to determining that the at least one enhancement condition has been met, converting the image data to enhanced image data, the enhanced image data including an increased readability of the visual information display on the object.

2. The method of claim 1, wherein determining the frustration level further comprises determining one of a sentiment of the user, a facial expression of the user, and biometric data associated with the user.

3. The method of claim 1, further comprising:
receiving historical data associated with the user;
determining a current location of the device; and
determining, from the historical data, whether a current context associated with the current location is similar to a previous context associated with a previous location.

4. The method of claim 3, wherein the enhancement condition is further based upon determining that the current context is similar to the previous context.

5. The method of claim 1, wherein the enhancement condition is determined using one or more of calendar data associated with the user, historical data associated with the user, user biometric data, and environmental data associated with an environment of the user.

6. The method of claim 1, wherein converting the image data to enhanced image data further comprises increasing legibility of a portion of the visual information.

7. The method of claim 1, wherein converting the image data to enhanced image data further comprises increasing a contrast of a portion of the image data.

8. The method of claim 1, wherein converting the image data to enhanced image data further comprises changing one or more colors of a portion of the image data.

9. The method of claim 1, wherein converting the image data to enhanced image data further comprises changing a font of a portion of the visual information.

10. The method of claim 1, wherein converting the image data to enhanced image data further comprises zooming in on a portion of the image data including a portion of the visual information.

11. The method of claim 1, wherein converting the image data to enhanced image data further comprises changing an orientation of the image data.

12. The method of claim 1, further comprising:
determining whether the frustration level associated with the user continues to exceed the threshold value;
responsive to determining that the frustration level continues to exceed the threshold, presenting the visual information in an alternate format.

13. The method of claim 12, presenting the visual information in the alternate format further includes presenting the visual information in an audio format.

14. The method of claim 1, wherein the visual information includes textual information.

15. A computer usable program product comprising one or more computer-readable storage devices, and program instructions stored on at least one of the one or more storage devices, the stored program instructions comprising:
program instructions to configure profile data associated with a user of a device, the profile data indicating a condition of the user associated with a visual impairment;
program instructions to capture image data associated with an object, the object including visual information displayed thereon;
program instructions to display the image data in a display associated with the device;
program instructions to evaluate a frustration level associated with the user, the frustration level indicative of the user viewing the image data in the display;
program instructions to determine whether an enhancement condition has been met based upon the condition of the user and whether the frustration level has exceeded a threshold value; and
program instructions to, responsive to determining that the at least one enhancement condition has been met, convert the image data to enhanced image data, the enhanced image data including an increased readability of the visual information displayed on the object.

16. The computer usable program product of claim 15, further comprising:
program instructions to receive historical data associated with the user;
program instructions to determine a current location of the device; and
program instructions to determine, from the historical data, whether a current context associated with the current location is similar to a previous context associated with a previous location.

17. The computer usable program product of claim 16, wherein the enhancement condition is further based upon determining that the current context is similar to the previous context.

18. The computer usable program product of claim 15, wherein the computer usable code is stored in a computer readable storage device in a data processing system, and wherein the computer usable code is transferred over a network from a remote data processing system.

19. The computer usable program product of claim 15, wherein the computer usable code is stored in a computer readable storage device in a server data processing system, and wherein the computer usable code is downloaded over a network to a remote data processing system for use in a computer readable storage device associated with the remote data processing system.

20. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to configure profile data associated with a user of a device, the profile data indicating a condition of the user associated with a visual impairment;
program instructions to capture image data associated with an object, the object including visual information displayed thereon;
program instructions to display the image data in a display associated with the device;
program instructions to evaluate a frustration level associated with the user, the frustration level indicative of the user viewing the image data in the display;
program instructions to determine whether an enhancement condition has been met based upon the condition of the user and whether the frustration level has exceeded a threshold value; and
program instructions to, responsive to determining that the at least one enhancement condition has been met, convert the image data to enhanced image data, the enhanced image data including an increased readability of the visual information displayed on the object.
